(19) United States
(12) Patent Application Publication
(10) Pub. No.: US 2025/0315543 A1
(43) Pub. Date: Oct. 9, 2025

(54) METHOD AND SYSTEM FOR PROVIDING INDIRECT VISUALIZATION ACCESS OF A DATA-LAKE

(71) Applicant: HCL Technologies Limited, New Delhi (IN)

(72) Inventors: Himanshu Dubey, Noida (IN); Prathameshwar Pratap Singh, Noida (IN); Yogesh Gupta, Noida (IN)

(21) Appl. No.: 19/077,233

(22) Filed: Mar. 12, 2025

(30) Foreign Application Priority Data
Apr. 5, 2024 (IN) 202411028116

(51) Int. Cl. G06F 21/62; H04L 9/32

(52) U.S. Cl. CPC G06F 21/6227; H04L 9/32

(57) ABSTRACT

A method and system of providing indirect and visualization access to data of a data-lake is disclosed. A user request from a user to access the data of the data lake is received. A user profile from a plurality of user profiles associated with the user is determined based on a first level of authentication. The first level of authentication is based on the domain object name and the public key. A user defined function (UDF) from a plurality of predefined UDFs associated with the user profile is determined based on the first level of authentication. A portion of the data of the data-lake requested in the user request is selectively rendered based on a second level of authentication. The second level of the authentication is based on the domain object name and the private key.

### TECHNICAL FIELD

This disclosure relates generally to data-lake management, and more particularly to a method and system for providing indirect visualization access of a data-lake.

### BACKGROUND

A data lake is a centralized repository designed to store, process, and secure large amounts of structured, semi-structured, and unstructured data. Data lakes are open format, low cost, and highly durable. They can be used for data analytics, business intelligence, and machine learning. Due to versatility of use of data lakes, it's crucial to control access of private data stored in data lakes to maintain its confidentiality. Current methods of accessing data lakes include setting up semantic layer applications through which data may be accessed. However, such access methods require domain knowledge of access tools, and a deep understanding of the actual data housed within the data lake. These methods only offer limited ways to secure data access by a user.

Existing solutions suggest utilization of a semantic layer that may control how data is accessed or queried. However, such access methodologies do not prevent access of data of the data lake including private data. Since data of the data-lake is made visible to the semantic layer, there are increased chances of the data getting leaked or manipulated.

Therefore, there is a need for a method and system for providing indirect visualization access of a data-lake.

### SUMMARY OF THE INVENTION

In an embodiment, a method for providing indirect and visualization access to data of a data-lake is disclosed. The method may include receiving, by a processor via a semantic schema layer (SSL), a user request from a user to access the data of the data-lake. In an embodiment, the user request may include a domain-object, a public key and a private key. The method may further include determining, by the processor via the SSL, a user profile from a plurality of user profiles associated with the user based on a first level of authentication. In an embodiment, the plurality of user profiles corresponds to a plurality of users. In an embodiment, the first level of authentication may be based on the domain object name and the public key. The method may further include determining, by the processor via a user access layer (UAL), a user defined function (UDF) from a plurality of predefined UDFs associated with the user profile based on the first level of authentication. The method may further include selectively rendering, by the processor via the UAL, a portion of the data of the data-lake requested in the user request based on a second level of authentication. In an embodiment, the second level of authentication may be based on the domain object name and the private key. In an embodiment, the portion of the data may be retrieved from the data-lake based on the UDFs and the second level of authentication.

In another embodiment, a system for providing indirect and visualization access to data of a data-lake. The system may include a processor, and a memory coupled to the processor. The memory stores processor-executable instructions, which, on execution, cause the processor to receive a user request from a user via a semantic schema layer (SSL) to access the data of the data-lake. In an embodiment, the user request may include a domain object name, a public key, and a private key. The processor may further determine a user profile from a plurality of user profiles associated with the user via the SSL based on a first level of authentication. In an embodiment, the plurality of user profiles may correspond to a plurality of users. In an embodiment, the first level of authentication may be based on the domain object name and the public key. The processor may further determine a user defined function (UDF) from a plurality of predefined UDFs associated with the user profile via a user access layer (UAL) based on the first level of authentication. The processor may further selectively render a portion of the data of the data-lake requested in the user request via the UAL based on a second level of authentication. In an embodiment, the second level of authentication may be based on the domain object name and the private key. In an embodiment, the portion of the data may be retrieved from the data-lake based on the UDFs and the second level of authentication.

In another embodiment, a non-transitory computer-readable medium storing computer-executable instructions for providing indirect and visualization access to data of a data-lake is disclosed. The computer-executable instructions may be configured for receiving via a semantic schema layer (SSL), a user request from a user to access the data of the data-lake. In an embodiment, the user request may include a domain object name, a public key, and a private key. The computer-executable instructions configured for determining via the SSL, a user profile from a plurality of user profiles associated with the user based on a first level of authentication. In an embodiment, the plurality of user profiles may correspond to a plurality of users. In an embodiment, the first level of authentication may be based on the domain object name and the public key. The computer-executable instructions configured for determining via a user access layer (UAL), a user defined function (UDF) from a plurality of predefined UDFs associated with the user profile based on the first level of authentication. The computer-executable instructions configured for selectively rendering via the UAL, a portion of the data of the data-lake requested in the user request based on a second level of authentication. In an embodiment, the second level of the authentication may be based on the domain object name and the private key. In an embodiment, the portion of the data may be restricted from the data-lake based on the UDFs and the second level of authentication.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of a system for providing indirect visualization access of a data-lake, in accordance with an embodiment of the current disclosure.

FIG. 2 illustrates a functional block-diagram of a computing device 102 for providing indirect visualization access of a data-lake, in accordance with an embodiment of the present disclosure.

FIG. 3A illustrates an exemplary dataset housed in a data-lake, in accordance with an embodiment of the present disclosure.

FIG. 3B illustrates an exemplary portion of the dataset as selectively rendered to a user, in accordance with an embodiment of the present disclosure.

FIG. 4 illustrates a flowchart of a method of providing indirect and visualization access of a data-lake, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed.

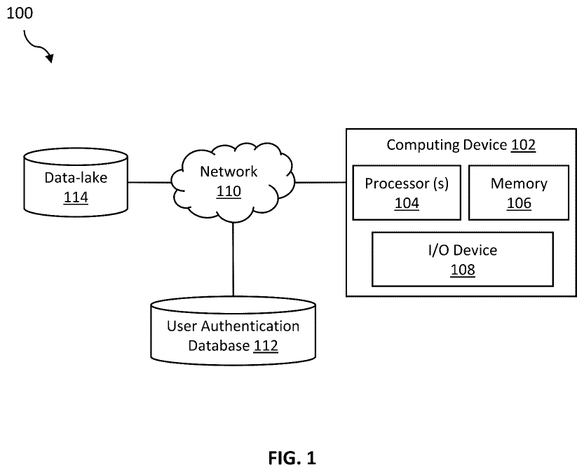

The present disclosure provides a system and a method for providing indirect visualization access of a data-lake in order to overcome the issues of the conventional arts. FIG. 1 illustrates a block diagram of a system 100 for providing indirect and visualization access to data of a data-lake 114, in accordance with an embodiment of the present disclosure. The system 100 may include a computing device 102, a user authentication database 112, and the data-lake 114 communicably coupled to each other through a wireless communication network 110. The computing device 102 may include a processor 104, a memory 106, and input/output (I/O) device 108.

In an embodiment, examples of processor(s) 104 may include, but are not limited to, an Intel® Itanium® or Itanium 2 processor(s), or AMD® Opteron® or Athlon MP® processor(s), Motorola® lines of processors, Nvidia®, FortiSOC™ system on a chip processors or other processors that can be used to execute similar functions.

In an embodiment, the memory 106 may store instructions that, when executed by the processor 104, may cause the processor 104 to provide indirect and visualization access of the data-lake 114, as discussed in more detail below. In an embodiment, the memory 106 may be a non-volatile memory or a volatile memory. Examples of non-volatile memory may include, but are not limited to, a flash memory, a Read Only Memory (ROM), a Programmable ROM (PROM), Erasable PROM (EPROM), and Electrically EPROM (EEPROM) memory. Further, examples of volatile memory may include, but are not limited to, Dynamic Random Access Memory (DRAM), and Static Random-Access memory (SRAM).

In an embodiment, the I/O devices 108 may include variety of interface(s), for example, interfaces for data input and output devices, and the like. The I/O devices 108 may facilitate inputting of instructions to the computing device 102 by a user. In an embodiment, the I/O devices 108 may be wirelessly connected to the computing device 102 through wireless network interfaces such as Bluetooth®, infrared, Wi-Fi, or any other wireless communication technology known in the art. In an embodiment, the I/O devices 108 may be connected to a communication pathway for one or more components of the computing device 102 to facilitate the transmission of inputted instructions and output results of data generated by various components such as, but not limited to, processor(s) 104 and memory 106. In an embodiment, the data-lake 114 may be enabled in a cloud or may be a physical database. The data-lake 114 may store structured data, unstructured data or a combination thereof.

In an embodiment, the communication network 110 may be a wired or a wireless network or a combination thereof. The network 110 can be implemented as one of the different types of networks, such as but not limited to, ethernet IP network, intranet, local area network (LAN), wide area network (WAN), the internet, Wi-Fi, LTE network, CDMA network, 5G and the like. Further, the network 110 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 110 can include a variety of network devices, including routers, bridges, servers, computing devices, storage devices, and the like.

In an embodiment, the computing device 102 may receive a request to provide indirect visualization access of the data-lake 114 from a user using an I/O device 108. In an embodiment, the computing device 102 may be a computing system, including but not limited to, a smart phone, a laptop computer, a desktop computer, a notebook, a workstation, a portable computer, a handheld device or a mobile device.

In an embodiment, the indirect visualization access of the data of the data lake 114, may be based on an authentication of a registered user profile by a semantic schema layer (SSL). In an embodiment, the SSL may act as an interface between a user and the data-lake 114. Further, a user profile may be registered by a user access layer (UAL) different from the SSL, based on defining a domain object name, a public key and a private key corresponding to each of the plurality of user profiles. In an embodiment, each of the plurality of user profiles may include a unique domain object name, a public key and one or more private keys. In an embodiment, the user authentication database 112 may store data corresponding to each of the plurality of user profiles generated based on the registration of one or more users.

In an embodiment, the user profiles may be registered based on registration of users by the computing device 102 in order to access data of the data-lake 114. In an embodiment, the user authentication database 112 may include data of the plurality of user profiles of the users registered. In an embodiment, an administrator may register one or more registered users and may create one or more user profiles. In an embodiment, an administrator may include, but is not limited to, owner of an organization, head of a department, or a manager, etc.

In an embodiment, the registration of the user profile may further include creation of a plurality of user defined functions (UDFs) associated with the user profile. In an embodiment, the plurality of UDFs associated with the user profile may be created via the UAL. In an embodiment, the UAL may be different from the SSL. In an embodiment, each of the plurality of UDFs may be stored in the data-lake 114 and may be determined via a query management layer (QML) of the data lake 114. In an embodiment, the plurality of UDFs may be created to provide indirect visualization access of the data of the data lake 114 via the QML. In an embodiment, the UDFs may be dynamically and created based on the domain object name associated with the user profile and stored in the data-lake 114.

Further, the computing device 102 may create, via the UAL, for each of the plurality of UDFs, a unique query, and a unique schema. In an embodiment, a corresponding query and a corresponding schema associated with the UDF may be created based on an access level from a plurality of access levels associated with the user profile. In an embodiment, a plurality of access levels may be defined based on designation of a user in an entity or as defined by the administrator. In an embodiment, the plurality of access levels may include, but not limited to, an executive access, a supervisory access and an administrator access. In another embodiment, an access type associated with the plurality of user profiles may include a public access, a private access and a protected access.

Accordingly, based on the registration of the user, a user profile may be created that may include a domain object name that may be assigned one of the plurality of access levels and an access type by an administrator via the UAL and saved in the user authentication database 112. Further, a plurality of UDFs may be created by the UAL associated with the corresponding user profile based on the access level and the access type associated with the user profile. In an embodiment, creation of each of the plurality of UDFs may include creation of a unique query and a unique schema. In an embodiment, a corresponding query and a corresponding schema associated with the UDF may be created based on the access level from the plurality of access levels associated with the user profile.

Further, the creation of the user profile may include defining a public key and one or more private keys. In an embodiment, each UDF from the plurality of UDFs may be associated with a corresponding unique private key. In an embodiment, each of the plurality of UDFs may be accessed based on the corresponding unique private key. Notably, direct access to the data lake 114 may not be necessary for the creation of the user profile. In an embodiment, the memory 106 or the user authentication database 112 may save the plurality of user profiles generated based on the registration of the users. In an embodiment, the UDFs associated with each of the registered user profiles created for the registered users may be saved in the data-lake 114.

In an embodiment, in order to provide indirect and visualization access of the data of the data-lake 114, the computing device 102 may perform various processing as described further. By way of an example, the computing device 102 may receive, via the SSL, a user request from a user to access the data of the data lake 114. In an embodiment, the user request may include a domain object name, a public key, and/or a private key.

Further, the computing device 102 may determine, via the SSL, a user profile from a plurality of user profiles associated with the user based on a first level of authentication. In an embodiment, the plurality of user profiles may correspond to a plurality of registered users. In an embodiment, the first level of authentication may be based on the domain object name and the public key. In an embodiment, the first level of authentication may be performed to verify a user requesting the data access of the data lake 114. In an embodiment, the SSL may verify the public key input by the user based on the public key stored in the user authentication database 112 for the corresponding domain object name.

Further, the computing device 102 may determine, via the UAL, one or more UDFs associated with the user profile based on the first level of authentication. Further, the computing device 102 may selectively render, via the UAL, a portion of the data of the data lake 114 requested in the user request based on a second level of authentication. In an embodiment, the second level of the authentication may be based on the domain object name and the private key. In an embodiment, the portion of the data may be retrieved from the data-lake 114 based on the UDFs and the second level of authentication. Accordingly, the computing device 102 may determine the UDF based on a comparison of the private key input by the user with the private key stored in the user authentication database 112 associated with the corresponding UDFs associated with the user profile.

In an embodiment, the portion of the data may be retrieved from the data-lake 114 by establishing a connection between the UAL and the QML and by executing the corresponding query associated with the UDF. It is to be noted that the SSL may facilitate only the first level of authentication and the second level of authentication. Based on the first level of authentication, the corresponding one or more UDFs associated with the user profile stored in the data-lake 114 may be determined. Further, based on the second level of authentication the query associated with one UDF from the one or more UDFs may be executed.

In an embodiment, the corresponding query of the UDF from the plurality of UDFs may enable selective retrieval of the portion of the data of the data-lake 114 by encrypting, masking, and hiding of the data of the data-lake 114. In an embodiment, the corresponding schema of the UDF from the plurality of UDFs may enable the selective rendering of the portion of the data of the data-lake 114 based on a data representation format. The data representation format may include selection of a format and a structure of data in each of a plurality of data fields in a table representing the portion of the data.

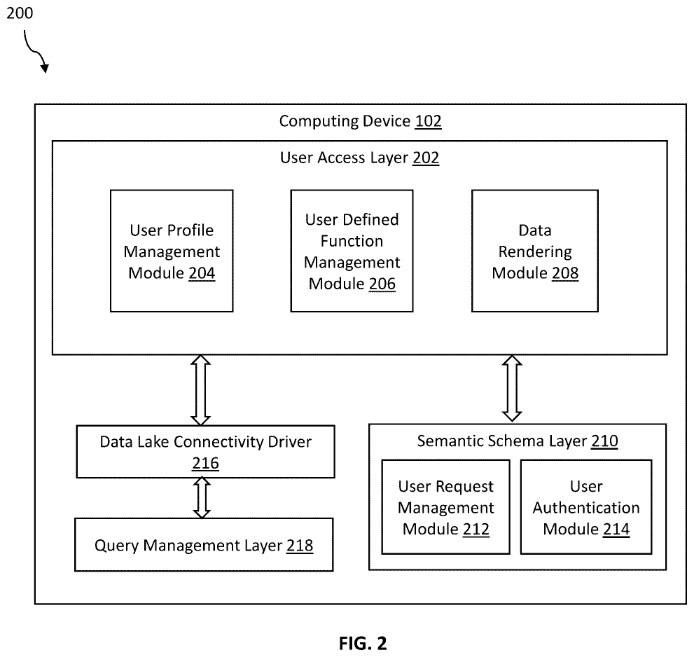

Referring now to FIG. 2, a functional block-diagram of a computing device 102 for providing indirect visualization access of a data-lake 114 is illustrated, in accordance with an embodiment of the present disclosure. FIG. 2 is explained in conjunction with FIG. 1. The computing device 102 may include a set of components. The set of components may include a user access layer (UAL) 202, a semantic schema layer (SSL) 210, a data-lake connectivity driver 216 and a query management layer (QML) 218.

The UAL 202 may include a user profile management module 204 and a user defined function management module 206. In an embodiment, the user profile management module 204 may allow registration of one or more users for providing indirect and visualization access of data of the data-lake 114. In an embodiment, the registration of a user may include defining a domain object name, a public key and a private key corresponding to a user profile. In an embodiment, each of the plurality of user profiles may include a unique domain object name, a public key and one or more private keys. In an embodiment, each of the plurality of user profiles may include a plurality of user attributes associated with each of the plurality of users. The plurality of user attributes may include, but are not limited to, at least one of employee ID, organization ID, team ID, business unit ID, user location, current designation, department, user type, access level and access type. In an embodiment, the domain object name may be user-defined or may be selected as, but not limited to, the employee ID. In an embodiment, the user authentication database 112 may store data corresponding to each of the plurality of user profiles generated based on the registration of one or more users.

Accordingly, the user profile management module 204 may allow a user to register by creating a user profile based on input of the plurality of user attributes and a domain object name, a public key and/or a private key. In one embodiment, the user profile management module 204 may allow an administrator having an administrator access to assign one of the plurality of access levels and/or an access type via the UAL 202. In an embodiment, the plurality of access levels may include, but are not limited to, an executive access, a supervisory access and an administrator access. In an embodiment, an access type associated with the plurality of user profiles may include a public access, a private access and a protected access. In an embodiment, a plurality of access levels may be dynamically defined based on designation of a user in an entity or as defined by the administrator. For example, the administrator may allow access of sales data stored in the data-lake 114 to the users of an accounts team of an entity. Further, the sales data may also be shared with the marketing team and the fulfillment team of the entity. In an embodiment, the sales data may include order information and cost information may include personal data and credit card information of buyers. Accordingly, personal data and credit card information of the buyers may be labeled as sensitive information and may not be shared with users which belong to the marketing team and the fulfillment team of the entity. In an embodiment, an executive access may allow access of data corresponding to all members belonging to a particular department, a supervisory access may allow access of data corresponding to a plurality of departments and an administrator access may include access of data corresponding to all users. Further, the data of the data-lake 114 may be segregated as public data, private data, and protected data. Accordingly, an access type of the public access may allow access of public data, private access may allow access of private data and protected access may allow access of protected data. In an embodiment, public access may allow access of public data only by hiding, masking or encrypting the protected data and the private data. Further, the protected access may allow access to public data and the protected data by hiding, masking or encrypting the private data. In an embodiment, the private access may allow access to public data, protected data and the private data. In an embodiment, masking may be performed using techniques such as, but not limited to, data obfuscation. In an embodiment, encryption of the data may be performed using cryptographic algorithms, such as, but not limited to, AES, RSA, etc.

Further, while registering the user profile, the user defined function (UDF) management module 206 may dynamically create one or more UDFs associated with the user profile. In an embodiment, the one or more UDFs may be dynamically created based on the user profile attributes, the access level and the access type.

In an embodiment, in order to define a UDF associated with the user profile a unique query and a unique schema may be defined or created. In an embodiment, the administrator may define one or more UDFs based on the user profile attributes, access level and access type.

In an embodiment, the unique query may be defined using the data lake connectivity driver 216 via the query management layer 218. In an embodiment, the unique query may be selected dynamically from a plurality of predefined queries. In an embodiment, the unique query may be defined based on customization of a predefined query from the plurality of predefined queries based on the access level and access type of the user.

Further, the UDF management module 206 may define the unique schema that may allow the data retrieved from the data-lake 114 using the unique query. The schema may allow the portion of data retrieved to be selectively rendered based on a data representation format. In an embodiment, the data representation format may define how the portion of data may be selectively rendered to a user on a display device. In an embodiment, the data representation format defines a format and a structure of data in each of a plurality of data fields in a table representing the portion of the data to be selectively rendered. Further, the unique schema may ensure that the portion of the data to be rendered to a user is in accordance with the access level and/or the access type of the user.

Further, each of the UDFs may be associated with a private key that may be generated using, but not limited to, a key generation algorithm and provided to the registered user. In one embodiment, the user may be allowed to define or input a private key during registration and creation of the UDFs. It is to be noted that the UDFs associated with a user profile during registration may be saved in the data-lake 114.

In an embodiment, the SSL 210 may include a user request management module 212 and a user authentication module 214. The user request management module 212 may receive a user request from a user to access the data of the data-lake 114. In an embodiment, the user request may include a domain object name, a public key, and a private key.

Further, the user authentication module 214 may perform first level of authentication based on the domain object name and the public key received from the user by the user request management module 212. Further, the user request management module 212 may determine a user profile associated with the user from a plurality of user profiles stored in the user authentication database 112 based on a success of the first level of authentication performed by the user authentication module 214. In an embodiment, the user authentication module 214 may map the domain object name and the public key received with the plurality of user profiles of the plurality of users registered by the user profile management module 204. In an embodiment, the first level of authentication may be based on verification of the mapping of the domain object name and the public key. Once the user profile may be determined, the user authentication module 214 may communicate the success of the first level of authentication with the UDF management module 206 of the UAL 202. The UDF management module 206 may then determine a one or more UDFs associated with the user profile based on the first level of authentication.

Further, the user authentication module 214 may perform a second level of authentication based on determining a UDF from the one or more UDFs corresponding to which the private key input by the user may match. Based on a successful second level of authentication and determination of the UDF, the UDF management module 206 may execute the unique query of the UDF. The execution of the unique query may be performed by communicably connecting to the data-lake 114 via the data lake connectivity driver 216 and via the query management layer 218. In an embodiment, the data-lake connectivity driver 216 may facilitate a connection between the QML 224 and the data-lake 114 to access and interact with the data housed in the data lake.

Further, the data rendering module 208 may selectively display a portion of the data of the data-lake 114 queried using the unique query from the data-lake 114. In an embodiment, the portion of data may be rendered based on the unique schema associated with the UDF executed.

Accordingly, the data rendering module 208 may selectively render a portion of the data of the data-lake 114 requested in the user request based on a second level of authentication. In an embodiment, the second level of the authentication may be based on the domain object name and the private key. In an embodiment, the portion of the data may be retrieved from the data-lake 114 based on the UDF and the second level of authentication by establishing a connection between the UAL 202 and the QML 218 and by executing the corresponding unique query associated with the UDF. Accordingly, the SSL 210 may be integrated with any external platforms without having to worry about exposing sensitive data of the data-lake 114.

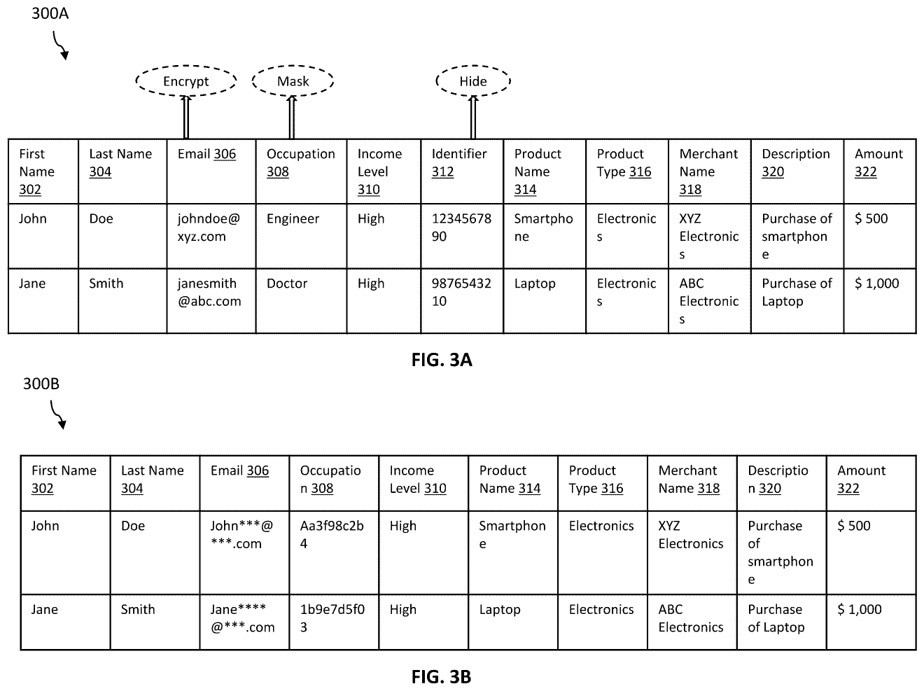

In an embodiment, the execution of the corresponding unique query of the UDF from the plurality of UDFs may enable selective retrieval of the portion of the data of the data-lake 114 by encrypting, masking, and hiding of the data of the data-lake 114. In an embodiment, the corresponding schema of the UDF from the plurality of UDFs enables the data rendering module 208 to selective render the portion of the data of the data-lake 114 based on a data representation format. In an embodiment, the data representation format may include selection of a format and a structure of data in each of a plurality of data fields in a table representing the portion of the data. It should be noted that the data rendered may provide an indirect visualization access of the portion of the data of the data-lake 114. Thus, the user may not be able to alter the data of the data-lake 114. Referring now to a FIG. 3A, an exemplary dataset 300A housed in a data-lake 114 is illustrated, in accordance with an embodiment of the present disclosure. In an exemplary embodiment, the exemplary dataset 300A housed in a data-lake 114 may be customer transaction data requested by the user via the user request management module 212 for various analytical and operational purposes. As can be seen in FIG. 3A, the dataset 300A may include a plurality of columns 302-322 providing information such as first name 302, last name 304, email 306, occupation 308, income level 310, identifier 312, product name 314, product type 316, merchant name 318, description 320, amount 322. As can be seen, the dataset 300A includes columns including private data such as email 306, occupation 308, identifier 312.

Referring now to FIG. 3B, an exemplary portion of dataset 300B that may be selectively rendered to a user is illustrated, in accordance with the exemplary embodiment of FIG. 3A. In continuation to the exemplary embodiment of FIG. 3A, based on the successful first level of authentication and the second level of authentication by the user authentication module 214. The UDF management module 206 may determine a UDF based on the second level of authentication and execute a unique query that may enable access of the dataset 300A from the data-lake 114. The data rendering module 208 may selectively retrieve the dataset 300B based on the unique schema defined in the UDF. As can be seen in FIG. 3B, the dataset 300B may be depicted as a table that may be rendered to the user by encrypting the data of column 306, masking the data of column 308 and hiding the data of column 312 of table 300A. Further, the table 300B may be rendered based on a data representation format predefined in the UDF. As can be seen, the data of the columns and rows may be formatted and structured to present the data in a legible manner. As can be seen, the data of column 322 may be formatted and structured to depict currency in “$”.

Accordingly, the dataset 300A housed within the data-lake 114 may encapsulate customer transaction data, crucial for various analytical and operational purposes. In an embodiment while creating the UDF for access of the dataset 300A, columns within this dataset 300A including private data may be masked, encrypted, and hidden from users based on access level and/or access type of the user. Accordingly, the portion of dataset depicted in table 300B may be retrieved by masking, encrypting and hiding the private data may ensure that only the authorized personnel can view and analyze data, thereby upholding data integrity and confidentiality.

As will be appreciated by one skilled in the art, a variety of processes may be employed for providing indirect visualization access of a data-lake 114. For example, the exemplary system 100 and the associated computing device 102 may provide indirect visualization access of a data-lake 114 by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

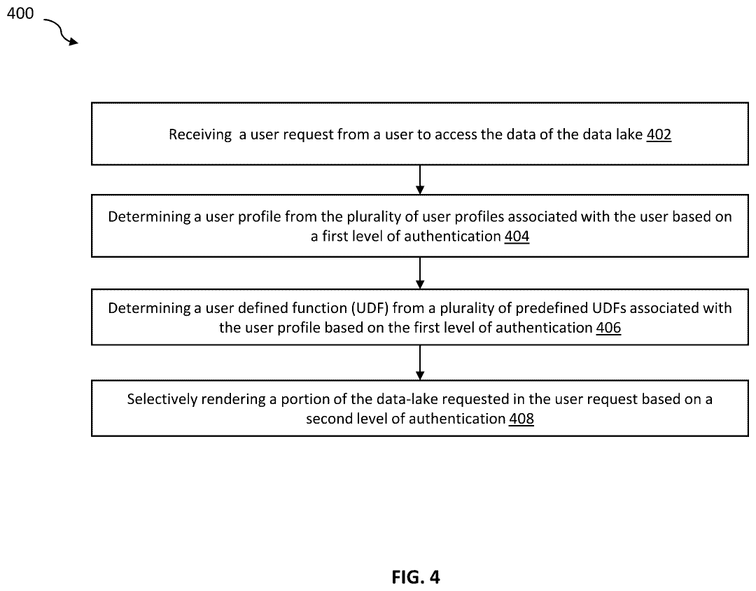

Referring now to FIG. 4, a flowchart 400 of a methodology of providing indirect and virtualization access of data of the data-lake 114 is illustrated, in accordance with an embodiment of the present disclosure. In an embodiment, method 400 may include a plurality of steps that may be performed by the processor 104 to provide indirect visualization access of a data-lake 114.

FIG. 4 is explained in conjunction with FIGS. 1 and 2. Each step of the flowchart 400 may be executed by various modules of the computing device 102.

At step 402, a user request may be received from a user to access the data of the data-lake 114. In an embodiment the user request may include a domain object name, a public key and a private key. Further at step 404, a user profile from a plurality of user profiles associated with the user may be determined based on a first level of authentication. In an embodiment, the plurality of user profiles may correspond to a plurality of users. In an embodiment, the plurality of user profiles may be generated based on registration of the plurality of users. In an embodiment, the first level of authentication may be based on the domain object name and the public key.

Further at step 406, a user defined function (UDF) from a plurality of predefined UDFs associated with the user profile may be determined based on the first level of authentication. In an embodiment, each of a plurality of UDFs associated with the user profile may be created based on the registration of the user. In an embodiment, the each of the plurality of UDFs may be communicatively coupled to a query management layer (QML) of the data-lake 114 and may be stored in the data-lake 114.

Further the creation of a UDF from the plurality of UDFs may include creation of a unique query and a unique schema. In an embodiment, a corresponding query and a corresponding schema may be associated with the UDF may be created based on an access level from a plurality of access levels associated with the user profile.

Further at step 408, a portion of the data of the data-lake 114 requested in the user request may be selectively rendered based on a second level of authentication. In an embodiment, the second level of authentication may be based on the domain abject name and the private key. In an embodiment, the portion of the data may be retrieved from the data-lake 114 based on the UDFs and the second level of authentication. In an embodiment, the portion of the data may be retrieved from the data-lake 114 by establishing a connection between the UAL and the QML and by executing the corresponding query associated with the UDF.

In an embodiment, the corresponding query of the UDF from the plurality of UDFs may enable selective retrieval of the portion of the data of the data-lake 114 by encrypting, masking, and hiding of the data of the data-lake 114. In an embodiment, the corresponding schema of the UDF from the plurality of UDFs may enable the selective rendering of the portion of the data of the data-lake 114 based on a data representation format. In an embodiment, the data representation format may include selection of a format and a structure of data in each of a plurality of data fields in a table representing the portion of the data.

Thus, the disclosed method and system tries to overcome the technical problem associated with secure data handling in data lakes, by proposing a framework for managing sensitive data while ensuring compliance with data privacy regulations and enhancing user experience. The disclosed method and system provide secure data retrieval for secure read-only access to the data lake. By incorporating encryption, masking, and access controls, the disclosed method and system addresses secure data access, personalized data retrieval, enhanced data security and privacy, and controlled access and authorization.

The disclosed method and system introduce a novel solution for generating a data blind and schema-conscious semantic layer to facilitate data extraction from data lakes. This involves creating dynamic functions at the individual user level to encapsulate object definitions, access controls, and user personas. Additionally, a handshake mechanism based on public and private keys is implemented to reinforce data security and regulate access.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described a method and system for providing indirect visualization access of a data-lake 114. The illustrated steps are set out to explain the exemplary embodiments shown, and it should be anticipated that ongoing technological development will change the manner in which particular functions are performed. These examples are presented herein for the purpose of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, non-volatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A method for providing indirect and visualization access to data of a data-lake, the method comprising:
receiving, by a processor and via a semantic schema layer (SSL), a user request from a user to access the data of the data-lake, wherein the user request comprises a domain object name, a public key and a private key;
determining, by the processor and via the SSL, a user profile from a plurality of user profiles associated with the user based on a first level of authentication,
wherein the plurality of user profiles corresponds to a plurality of users, and
wherein the first level of authentication is based on the domain object name and the public key;
determining, by the processor and via a user access layer (UAL), a user defined function (UDF) from a plurality of predefined UDFs associated with the user profile based on the first level of authentication; and
selectively rendering, by the processor and via the UAL, a portion of the data of the data-lake requested in the user request based on a second level of authentication,
wherein the second level of the authentication is based on the domain object name and the private key, and
wherein the portion of the data is retrieved from the data-lake based on the UDFs and the second level of authentication.

2. The method of claim 1, further comprising:
creating, by the processor and via the UAL, each of the plurality of UDFs associated with the user profile,
wherein the each of the plurality of UDFs are communicatively coupled to a query management layer (QML) of the data-lake,
creating, by the processor and via the UAL, for each of the plurality of UDFs, a unique query and a unique schema.

3. The method of claim 2, wherein a corresponding query and a corresponding schema associated with the UDF are created based on an access level from a plurality of access levels associated with the user profile.

4. The method of claim 3, wherein the portion of the data is retrieved from the data-lake by establishing a connection between the UAL and the QML and by executing the corresponding query associated with the UDF.

5. The method of claim 3, wherein the corresponding query of the UDF from the plurality of UDFs enables selective retrieval of the portion of the data of the data-lake by encrypting, masking, and hiding of the data of the data-lake.

6. The method of claim 3, wherein the corresponding schema of the UDF from the plurality of UDFs enables the selective rendering of the portion of the data of the data-lake based on a data representation format.

7. The method of claim 6, wherein the data representation format comprises selection of a format and a structure of data in each of a plurality of data fields in a table representing the portion of the data.

8. The method as claimed in claim 1, wherein the public key is stored within the SSL and the private key is input by the user.

9. A system for providing indirect and visualization access to data of a data-lake, comprising:
a processor; and
a memory coupled to the processor, wherein the memory stores processor-executable instructions, which, on execution, cause the processor to:
receive a user request from a user via a semantic schema layer (SSL) to access the data of the data-lake, wherein the user request comprises a domain object name, a public key and a private key;
determine a user profile from a plurality of user profiles associated with the user via the SSL based on a first level of authentication,
wherein the plurality of user profiles corresponds to a plurality of users, and
wherein the first level of authentication is based on the domain
object name and the public key;
determine a user defined function (UDF) from a plurality of predefined UDFs associated with the user profile via a user access layer (UAL) based on the first level of authentication; and
selectively render a portion of the data of the data-lake requested in the user request via the UAL based on a second level of authentication,
wherein the second level of authentication is based on the domain object name and the private key, and
wherein the portion of the data is retrieved from the data-lake based on the UDFs and the second level of authentication.

10. The system of claim 9, wherein the processor is configured to:
create each of the plurality of UDFs via the UAL associated with the user profile,
wherein the each of the plurality of UDFs are communicatively coupled to a query management layer (QML) of the data-lake,
create a unique query and a unique schema for each of the plurality of UDFs via the UAL.

11. The system of claim 10, wherein a corresponding query and a corresponding schema associated with the UDF are created based on an access level from a plurality of access levels associated with the user profile.

12. The system of claim 11, wherein the portion of the data is retrieved from the data-lake by establishing a connection between the UAL and the QML and by executing the corresponding query associated with the UDF.

13. The system of claim 11, wherein the corresponding query of the UDF from the plurality of UDFs enables selective retrieval of the portion of the data of the data-lake by encrypting, masking, and hiding of the data of the data-lake.

14. The system of claim 11, wherein the corresponding schema of the UDF from the plurality of UDFs enables the selective rendering of the portion of the data of the data-lake based on a data representation format.

15. The system of claim 14, wherein the data representation format comprises selection of a format and a structure of data in each of a plurality of data fields in a table representing the portion of the data.

16. The system of claim 9, wherein the public key is stored within the SSL and the private key is input by the user.

17. A non-transitory computer-readable medium storing computer-executable instructions for providing indirect and visualization access to data of a data-lake, the computer-executable instructions configure for:
receiving, via a semantic schema layer (SSL), a user request from a user to access the data of the data-lake, wherein the user request comprises a domain object name, a public key and a private key;
determining, via the SSL, a user profile from a plurality of user profiles associated with the user based on a first level of authentication,
wherein the plurality of user profiles corresponds to a plurality of users, and
wherein the first level of authentication is based on the domain object name and the public key;
determining, via a user access layer (UAL), a user defined function (UDF) from a plurality of predefined UDFs associated with the user profile based on the first level of authentication; and
selectively rendering, via the UAL, a portion of the data of the data-lake requested in the user request based on a second level of authentication,
wherein the second level of the authentication is based on the domain object name and the private key, and
wherein the portion of the data is retrieved from the data-lake based on the UDFs and the second level of authentication.

18. The non-transitory computer-readable medium of claim 17, wherein, the computer-executable instructions configure for:
creating, via the UAL, each of the plurality of UDFs associated with the user profile,
wherein the each of the plurality of UDFs are communicatively coupled to a query management layer (QML) of the data-lake,
creating, via the UAL, for each of the plurality of UDFs, a unique query and a unique schema.

19. The non-transitory computer-readable medium of claim 18, wherein a corresponding query and a corresponding schema associated with the UDF are created based on an access level from a plurality of access levels associated with the user profile.

20. The non-transitory computer-readable medium of claim 19, wherein the portion of the data is retrieved from the data-lake by establishing a connection between the UAL and the QML and by executing the corresponding query associated with the UDF.
